(19) United States
(12) Patent Application Publication
(10) Pub. No.: US 2004/0096589 A1
(43) Pub. Date: May 20, 2004

(54) Anti soiling coating composition and process for use thereof

(76) Inventor: Anthony B. Eoga, Boonton, NJ (US)

Correspondence Address: Steven B. Stein, Esq., Stein & Stein, 164 Route 10 West, Succasunna, NJ, 07876, US

(21) Appl. No.: 10/699,983

(22) Filed: Nov. 3, 2003

Related U.S. Application Data
(62) Division of application No. 09/751,160, filed on Dec. 28, 2000.

(51) Int. Cl. B05D 3/02

(52) U.S. Cl. 427/385.5

(57) ABSTRACT

The present invention provides a coating composition useful for protecting and cleaning surfaces from markings and soiling. The present invention further provides a process for coating and cleaning surfaces using the provided composition.

The present application is a continuing application and claims priority to U.S. application Ser. No. 09/751,160, filed on Dec. 28, 2000, which is hereby incorporated by reference in its entirety.

### FIELD OF THE INVENTION

The present invention relates to a coating composition useful for protecting and cleaning surfaces from markings such as graffiti, indelible ink, coffee, pencil marks, crayon marks, shoe polish, oil based residues, mascara, make-up and microbial residues such as mold and mildew. The present invention more particularly relates to a composition and a process of using the composition to protect surfaces and provide a means for the easy removal and cleaning of markings such as indelible ink marks, microbial residues, coffee stains, pencil marks, crayon marks, shoe polish, oil based residues, mascara, make-up and markings such as paint.

### BACKGROUND OF THE INVENTION

Soiling such as graffiti, indelible ink marks, coffee stains, pencil marks, crayon marks, shoe polish stains, oil based residues and microbial residues are unsightly, and in some cases it is a form of vandalism to buildings, public transportation, animate and inanimate visible surfaces. It is a problem for interior, exterior and other surfaces. Interior graffiti which includes interior walls in schools, buses, subways, public buildings, rest rooms, etc. are applied primarily using flexible tip permanent marking pens, coffee, pencil marks, crayon marks, shoe polish, oil based residues and microbial residues.

Exterior graffiti, which includes concrete abutments, bridges, walls of buildings, subways, etc. are applied usually with canned spray paints that are typically oil based. Intentional markings on animate surfaces such as mascara and make-up are difficult to remove an in some cases harsh chemical treatments are required.

Other surfaces including, but not limited to leather products, fabrics, textiles, plastics, woods and metals, which are marked usually unintentionally with scoff marks. Such marking are difficult to remove and in some cases the leather surface is discolored when rubbed or cleaned with harsh chemicals.

A method to counteract anti-soiling problems is to apply a protective coating onto a surface to protect it and which act as a sacrificial coating that both prevents the transmission of the soiling through the coating and allows removal of the soiling. U.S. Pat. No. 4,241,141 discloses a removable anti-graffiti coating. However, this coating requires cleaning solutions to remove it. U.S. Pat. No. 5,387,434 discloses another removable anti-graffiti coating, however, this coating requires power washing at a pressure of greater than 250 pounds per square inch (psi) to remove the coating. U.S. Pat. No. 5,750,269 discloses a removable anti-graffiti coating. However, this coating requires hot water and/or steam to remove it and therefore it is not suitable for animate surfaces and inanimate surfaces such as wallcoverings and wallpapers.

It is very desirable to be able to inexpensively protect the animate and inanimate surfaces from soiling and graffiti and to be able to easily remove these protective coatings in an environmentally friendly manner, such as water at ambient temperature. It is also very desirable to simultaneously clean and re-shield the animate and inanimate surfaces with the same composition, and prevent the transmission of the soiling materials.

The present invention provides distinct advantages over the prior art and solves numerous problems long described and understood in the field.

### SUMMARY OF THE INVENTION

It is therefore an object of this invention to provide a composition for coating a surface comprising (a) polyethylene oxide and (b) water. More specifically, it is an object of this invention to provide a composition for coating a surface further comprising (c) a surfactant. It is also an object of this invention to provide a composition for cleaning a surface.

It is a further object of this invention to provide a composition for coating a surface comprising (a) about 0.1 to 10 weight percent of a water soluble ether and (b) water. More specifically, it is an object of this invention to provide a composition for coating a surface further comprising an anionic surfactant. It is also an object of this invention to provide a composition for cleaning a surface.

It is a still further object of this invention to provide a process of coating a surface comprising the step of: (a) applying the provided composition to the surface. more Specifically it is an object of this invention to provide the process of coating a surface with the provided composition further comprising the step of: (b) drying the surface after coating step (a).

Even still further it is an object of the present invention to provide an article of manufacture comprising a surface treated with the provided composition.

### DETAILED DESCRIPTION OF THE INVENTION

The present invention provides a composition for coating a surface comprising (a) polyethylene oxide and (b) water.

One embodiment of the present invention is further comprising (c) a surfactant. According to another embodiment of the present invention, the polyethylene oxide concentration is about 0.01 to 50 weight percent. According to yet another embodiment of the present invention, the surfactant is an anionic surfactant. According to still another embodiment of the present invention, the polyethylene oxide is a high molecular weight polyethylene oxide. Still, according to another embodiment of the present invention, the polyethylene oxide is of a density of about 0.5 grams/ml. Further still, according to an embodiment of the present invention, the polyethylene oxide is of a molecular weight in the range of about 100,000 to 8,000,000. According to another embodiment of the present invention, the provided composition is further comprising a coloring agent. It is contemplated that the coloring agent of this embodiment, includes but is not limited to paint, dye and tint of any origin. The coloring agent may be combined with the provided composition, thereby giving color to the composition. According to yet still another embodiment of the present invention, the provided composition may be combined with a colored solution, including but not limited to paint, dye and tint of any origin, thereby comprising the provided composition. Thus, a paint preparation combined with the provided composition will yield a composition of the present invention suitable for use as a paint, the composition having particular properties as provided herein. According to another embodiment of the present invention, the provided composition is further comprising a fragrancing agent. According to another embodiment of the present invention, the provided composition further comprises an anti-microbial agent. According to another embodiment of the present invention, the provided composition further comprises an anti-soiling agent. According to one embodiment of the present invention, the anti-soiling agent is a detergent. The present invention contemplates that the provided composition may be combined with an anti-soiling agent, detergent or cleaning agent thereby yielding a composition as provided herein. According to yet still another embodiment of the present invention, the provided composition. According to an embodiment of the present invention, the anti-soiling agent concentration is about 0.01 to 99.9 weight percent.

Surfactants contemplated by the present invention include but are not limited to sodium lauryl sulfonate, ammonium lauryl sulfonate, dodecyl benzene sulfonate, sodium lauryl ether sulfate, diethanolamine lauryl sulfate, ammonium salts of sulfated alcohol ethoxylates, sodium cocoyl isethionate, sodium N-methyl-N-oleoyl taurate, sodium N-methyl-N-cocyl taurate, triethanolamine lauryl sulfate, disodium monooleamide PEG-2 sulfosuccinate, petroleum sulfonates sodium salt, alkyl naphthalene sodium sulfonates, sodium lauroyl sarcosinate, and sodium alkyl sulfosuccinate. Other useful anionic surfactants include sodium or potassium dodecyl sulfate, sodium trioleate, sodium or potassium stearyl sulfate, sodium or potassium dodecyl benzene sulfonate, sodium or potassium stearyl sulfonate, triethanol amine salt of dodecyl sulfate, sodium laurate, sodium or potassium myristate, and sodium or potassium stearate.

The present invention further provides a composition for coating a surface comprising (a) about 0.1 to 10 weight percent of a water soluble ether and (b) water.

According to an embodiment of the present invention, the water-soluble ether is one selected from the group comprising (hydroxypropyl cellulose, sodium carboxymethylcellulose, carboxymethyl hydroxyethyl cellulose, and hydroxyethyl cellulose). One embodiment of the present invention is further comprising (c) a surfactant. According to another embodiment of the present invention, the polyethylene oxide concentration is about 0.01 to 50 weight percent. According to yet another embodiment of the present invention, the surfactant is an anionic surfactant. According to still another embodiment of the present invention, the polyethylene oxide is a high molecular weight polyethylene oxide. Still, according to another embodiment of the present invention, the polyethylene oxide is of a density of about 0.5 grams/ml. Further still, according to an embodiment of the present invention, the polyethylene oxide is of a molecular weight in the range of about 100,000 to 8,000,000. According to another embodiment of the present invention, the provided composition is further comprising a coloring agent. It is contemplated that the coloring agent of this embodiment, includes but is not limited to paint, dye and tint of any origin. The coloring agent may be combined with the provided composition, thereby giving color to the composition. According to yet still another embodiment of the present invention, the provided composition may be combined with a colored solution, including but not limited to paint, dye and tint of any origin, thereby comprising the provided composition. Thus, a paint preparation combined with the provided composition will yield a composition of the present invention suitable for use as a paint, the composition having particular properties as provided herein. According to another embodiment of the present invention, the provided composition is further comprising a fragrancing agent. According to another embodiment of the present invention, the provided composition further comprises an anti-microbial agent. An anti-microbial agent is understood by one of skill in the art to include any disinfectant, anti-bacterial, anti-fungal, anti-viral or biocidal agent. According to another embodiment of the present invention, the provided composition further comprises an anti-soiling agent. According to one embodiment of the present invention, the anti-soiling agent is a detergent. The present invention contemplates that the provided composition may be combined with an anti-soiling agent, detergent or cleaning agent thereby yielding a composition as provided herein. According to yet still another embodiment of the present invention, the provided composition. According to an embodiment of the present invention, the anti-soiling agent concentration is about 0.01 to 99.9 weight percent.

The present invention still further provides a process of coating a surface comprising the step of: (a) applying the provided composition to the surface. According to an embodiment of the present invention, the process of coating a surface with the provided composition is further comprising the step of: (b) drying the surface after coating step (a). According to an embodiment of the present invention the drying step is conducted at about 1-250 degrees Centigrade. According to a preferred embodiment, the drying temperature is room temperature. According to still another embodiment of the present invention, the process of coating a surface with the provided composition is further comprising the step of: removing the coating by applying an aqueous solution to the coated surface. According to a preferred embodiment, the aqueous solution is water. According to another preferred embodiment, the aqueous solution is a cleaning solution. According to a preferred embodiment, the aqueous solution is at a temperature of about less than 85 degrees Centigrade. According to a most preferred embodiment, the aqueous solution is at room temperature. According to an even further embodiment, the present invention is further comprising step of: applying an additional amount of the provided composition to the surface. The additional amount of the provided composition re-shields the surface. According to one embodiment of the present invention, the surface treated with the provided composition is inanimate. According to another embodiment of the present invention, the surface treated with the provided composition is animate. According to one embodiment of this invention, the animate surface is human skin. The present invention contemplates combining the provided composition with skin lotions, cleansers or creams for use as a cleaning or coating composition.

The present invention still further provides an article of manufacture comprising a surface treated with the provided composition. According to one embodiment of the present invention, the treated surface is a wallpaper. According to another embodiment of the present invention, the treated surface is a painted surface. According to another embodiment of the present invention, the treated surface is a tiled surface.

The invention discloses a coating composition that provides unexpected anti-soiling properties. The composition according to the present invention can be applied in the form of an aqueous emulsion by painting or spraying onto a surface such as ceramic tile, a wall surface and then allowed to dry to form a protective coating for the substrate. Once a permanent or undesirable marking is applied, the markings can be easily removed simply by the application of water at ambient temperature, such as in the form of a wet towel, spray or jet. According to another embodiment of the present invention, permanent or undesirable marking can be cleaned and removed by application of the provided composition.

The coating composition according to the present invention comprises about 0.01 to 10 weight percent of a polyethylene oxide.

The polyethylene oxide additive is in a concentration of about 0.01 to 10 weight percent, preferably about 0.10 to 7.0 weight percent with a weight percent of about 0.40 to 2.5 being more preferred. The polyethylene oxide according to the present invention provides stability to the resulting emulsion and the dried coating depending upon its use for interior or exterior use. Amounts much below about 0.1 weight percent are too little to provide this stability and the coating may be too easily removed simply by weather. Thus the amount used will be subject to its use for interior or exterior structured surfaces.

The polyethylene oxide of is preferably a high molecular weight polyethylene oxide having a density of about 0.5 grams/ml. The polyethylene oxide is a water soluble resin. The preferred polyethylene oxide is a high molecular weight in the range of 100,000 to 8,000,000.

Additionally, it is preferred that the weight ratio of polyethylene oxide to anionic surfactant to be within 90/10 to 70/30 based on dry materials.

Preparation of the compositions provided herein are preferably carried out at temperatures from about 20° C. to about 40° C. using a high speed mixer as required. It is preferable to avoid very high-speed agitation of dissolved polyethylene oxide in order to prevent shear degradation of the resin.

A preferred composition according to the present invention is in the form of an aqueous emulsion comprising polyethylene oxide and dodecylbenzene sulfonate in an aqueous solution having the total solids concentration of about 0.05 to 15 weight percent, preferably about 0.05 to 8 weight percent with a total solids concentration of about 0.1 to 5 weight percent being more preferred. The remaining materials are water and/or the generally acceptable paint formulas and water. At amounts much below 0.1 weight percent total solids a good anti-soiling coating is not provided without the application of numerous coatings. At amounts much above 10 weight percent solids the solution becomes too viscous to be easily applied and may not be required to achieve effective results.

A preferred composition according to the present invention is preferably formed first as a solution of polyethylene oxide or water-soluble ether and then the surfactant is added and mixed easily.

A preferred process of protecting (shielding) and applying the composition according to the present invention to a substrate comprises applying the provided composition to a surface and allowing the composition to dry. The process according to the present invention is preferably conducted under ambient temperature conditions. In some instances, an additional coating is also applied. The provided composition is preferably applied to a surface by spraying, wiping, painting, rubbing, dipping, soaking, rolling, or brushing or simply applied by hand.

The composition provided by the present invention may also be used when temporary intentional coatings are applied and later removed. When the surface with the provided composition is soiled or coated with graffiti or other treatment, it can be removed by the application of water at ambient temperature. The water temperature is preferably about 20° C. to 25° C. In the case of crayon and other paraffin wax soiling agents, the water temperature is preferably 40° C. to 60°.

Soiling agents on surfaces treated with the provided composition can be removed easily without the need for steam or high-pressure treatment. However, any method of removing this coating is applicable. Low-pressure warm water jet spray is also very effective and fast and does not require special equipment or chemicals for removal.

The provided composition may be combined with minor ingredients including but not limited to leveling agents and wetting agents such that when applied and dried on a substrate an effective removable anti-graffiti, anti-soiling and anti-intentional coating is obtained.

The application of the removable coating of this invention can be carried out using any suitable application technique including brushing, wiping, rolling, or spraying. The coating is allowed to dry which requires 5 to 10 minutes. After the coating is dry it can be subjected to soiling or make-up without penetration through the coating to the underlying substrate.

It is specifically contemplated by the present invention that a composition of the present invention may be used as an additive or treatment to certain substrates, including, but not limited to paints, varnishes, oils, cleaning compounds, disinfectants, detergents, wipes, fabrics, textiles, metals, papers, woods, plastics and cosmetics in order to confer certain properties to the substrate. Moreover, it is contemplated that a composition of the present invention may be used for treating a surface prior to soiling to facilitate cleaning or for cleaning an untreated surface after soiling.

The compositions and coatings of the present invention are illustrated by the following examples.

### EXAMPLES

### Example 1

### Preparation of Removable Coating Composition

Polyethylene oxide basic composition was prepared by adding 5 grams of polyethylene oxide to 100 ml of water. The solution was mixed at high speed until the solution was clear. This solution was the 5 weight percent polyethylene oxide solution (“the 5% polyethylene oxide solution”).

Anionic surfactant solution was prepared by adding 5 grams of sodium dodecylbenzene sulfonate to 100 ml of water. The solution was mixed at high speed until the solution was clear. This solution is the 5 weight percent anionic surfactant solution (“the 5% anionic surfactant solution”).

Coloring agent was combined with the polyethylene oxide basic composition and anionic surfactant forming the removable coating composition as follows: (a) 8 ml of the 5% polyethylene oxide solution; (b) 2 ml of the 5% anionic surfactant solution; and (c) 90 ml of flat paint (Benjamin Moore®). The solution was mixed approximately 10 to 30 seconds, thereby forming the aqueous emulsion paint composition (“the colored coating composition”).

### Example 2

### Protection and Cleaning of Inanimate Surfaces

Treating and Coating Surfaces.

The colored coating composition was applied to an inanimate structured wall surface using a polyurethane paintbrush to provide a smooth coating. (“the composition treated surface”).

A control aqueous emulsion paint solution was prepared, which did not contain polyethylene oxide or the surfactant (“the control solution”). The control solution was applied to another portion of the inanimate structured wall surface using a polyurethane paintbrush to provide a smooth coating. (“the control treated surface”)

The coatings were allowed to dry. After approximately 3 hours, the treated surfaces were dry to the touch.

Testing Coated Surfaces

Graffiti.

“Graffiti” in the form of coffee, pencil marks, indelible ink marks, crayon marks, shoe polish and oil based residues (“soiling agents”) was applied to each of the composition treated coating surfaces and the control treated coating surfaces.

The surfaces were allowed to dry for approximately 30 minutes. It was observed that the coating and graffiti and soiling remained intact.

Cleaning. Each of the composition treated surfaces and the control treated surfaces were subjected to cleaning with a wet towel at room temperature to remove the soiled coating and graffiti. (The towel was wetted with water).

Results. The graffiti and soiling agents were removed completely with no stains remaining on the composition treated coated surface with the following limitation: only the crayon marks required water temperature above room temperature for removal of the soiling agent. The crayon marks required approximately 50° C. water temperature for complete removal of the crayon marks. Graffiti applied to the control treated surfaces was not completely removed following the same treatment.

The composition treated surface facilitated removal of the soiling agent to a striking degree as compared to the control treated surface.

Treatment with the provided composition having different viscosity and density of polyethylene oxide provides similar results.

Conclusion

The results show that the provided composition comprising polyethylene oxide provided an effective coating on an inanimate surface, which protected against the permanent adhesion of different types of soiling agents. The provided composition is an effective anti-graffiti surface treatment.

### Example 3

### Protection and Cleaning of Tiled Surfaces

Preparation of Removable Coating Composition.

Polyethylene oxide aqueous solution was prepared by adding 2.5 grams of polyethylene oxide to 100 ml of water. The solution was mixed at high speed until the solution was clear. This solution was the 2.5 weight percent polyethylene oxide solution (“the 2.5% polyethylene oxide aqueous solution”).

Anionic surfactant solution was prepared by adding 5 grams of sodium dodecylbenzene sulfonate to 100 ml of water. The solution was mixed at high speed until the solution was clear. This solution is the 5 weight percent anionic surfactant solution (“the 5% anionic surfactant solution”)

Aqueous Removable coating composition was prepared by combining (a) 100 ml of the 2.5% polyethylene oxide aqueous solution; and (b) 10 ml of the 5% anionic surfactant solution. The components were mixed for approximately 10 to 30 seconds.

Treating and Coating Surfaces.

The aqueous removable coating composition was applied to one half of a ceramic tile using a polyurethane paintbrush to provide a smooth coating. (“the composition treated tile”).

A control aqueous solution was prepared, which did not contain polyethylene oxide or the surfactant (“the control solution”). The control solution was applied to another portion of the ceramic tile using a polyurethane paintbrush to provide a smooth coating. (“the control treated surface”)

The coatings were allowed to dry. After approximately 15 to 30 minutes, the treated ceramic tile surfaces were dry to the touch.

Testing Coated Surfaces

Graffiti.

“Graffiti” in the form of indelible ink marks was applied to each of the composition treated coating ceramic tile surfaces and the control treated ceramic tile surfaces.

The surfaces were allowed to dry for approximately 30 minutes. It was observed that the coating and graffiti remained intact on the tile surface.

Cleaning. Each of the composition treated ceramic tile surfaces and the control treated ceramic tile surfaces were subjected to cleaning with a wet towel at room temperature to remove the graffiti. (The towel was wetted with water).

Results. The graffiti was removed completely with no stains on the composition treated ceramic tile surface. Graffiti applied to the control treated surfaces was not completely removed following the same treatment. In addition, some of the aqueous removable coating composition was removed during the cleaning step. This “sacrificial coating” effectively protected the tile and was easily removed with a wet towel, without the need for steam or chemical treatment.

The composition treated surface facilitated removal of the graffiti to a striking degree as compared to the control treated surface.

Treatment with the provided composition having different viscosity and density of polyethylene oxide provides similar results.

Re-Shielding

Following cleaning of the tile and removal, in part, of the sacrificial coating, the aqueous removable coating composition was again applied to one half of a ceramic tile using a polyurethane paint brush to provide a smooth coating. (“the re-shielded tile”).

A control aqueous solution was prepared, which did not contain polyethylene oxide or the surfactant (“the control solution”). The control solution was applied to another portion of the ceramic tile using a polyurethane paintbrush to provide a smooth coating. (“the control treated surface”)

The coatings were allowed to dry. After approximately 15 to 30 minutes, the treated ceramic tile surfaces were dry to the touch.

Testing Coated Surfaces

Graffiti.

“Graffiti” in the form of indelible ink marks was applied to each of the re-shielded tile surfaces and the control treated ceramic tile surfaces.

The surfaces were allowed to dry for approximately 30 minutes. It was observed that the coating and graffiti remained intact on the tile surface.

Cleaning. Each of the re-shielded ceramic tile surfaces and the control treated ceramic tile surfaces were subjected to cleaning with a wet towel at room temperature to remove the graffiti. (The towel was wetted with water).

Results. The graffiti was removed completely with no stains on the composition treated ceramic tile surface. Graffiti applied to the control treated surfaces was not completely removed following the same treatment. In addition, the aqueous removable coating composition was, in part, removed during the cleaning step. This “sacrificial coating” effectively protected the tile and was easily removed with a wet towel, without the need for steam or chemical treatment. The indelible ink on the control treated tile surface remained visible even after the cleaning step.

The composition treated surface facilitated removal of the graffiti to a striking degree as compared to the control treated surface.

Treatment with the provided composition having different viscosity and density of polyethylene oxide provides similar results.

The ceramic tile can be protected repeatedly by repeating the treatment.

Re-Graffiti Cleaning

The ceramic tile previously treated and cleaned in the previous experiment was allowed to dry.

Indelible ink marks were applied to each of the previously cleaned composition treated ceramic tile surfaces and the control treated ceramic tile surfaces.

The surfaces were allowed to dry for approximately 30 minutes. It was observed that the coating and graffiti remained intact on the tile surface.

Cleaning. Each of the previously cleaned composition treated ceramic tile surfaces and the control treated ceramic tile surfaces were subjected to cleaning with a wet towel at room temperature to remove the graffiti. (The towel was wetted with water).

Results. The graffiti was removed completely with no stains on the previously cleaned composition treated ceramic tile surface. Graffiti applied to the control treated surfaces was not completely removed following the same treatment. In addition. Thus the residual “sacrificial coating” effectively protected the tile and the graffiti was easily removed with a wet towel, without the need for steam or chemical treatment. The indelible ink on the control treated tile surface remained visible even after the cleaning step.

The composition treated surface facilitated removal of the graffiti to a striking degree as compared to the control treated surface.

Treatment with the provided composition having different viscosity and density of polyethylene oxide provides similar results.

The ceramic tile can be protected repeatedly by repeating the treatment.

Conclusion

The results show that the provided composition comprising polyethylene oxide provides an effective coating on an inanimate surface, which can protect against the permanent adhesion of different types of soiling agents. The provided composition is an effective anti-graffiti surface treatment.

### Example 4

### Protection and Cleaning of an Animate Surface

The 2.5% polyethylene oxide aqueous solution and the control solution were prepared as described in Experiment 3 herein above.

Treatment of Human Skin

The 2.5% polyethylene oxide aqueous solution was applied to the skin of the palm of one hand and allowed to dry (“the treated hand”). The control solution was applied to the other hand and allowed to dry (“the control hand”). After approximately 2 to 3 minutes the coating was dry to the touch. Indelible ink was applied to both hands and allowed to dry. It was observed that the coating and graffiti remained intact. After about 3 minutes, both hands were subjected to a cleaning with a wet towel. The towel was wet with water. at room temperature.

Results

The coating and graffiti were removed completely with no graffiti stain on the treated hand. The graffiti was not completely removed from the control hand.

The sacrificial coating was effective in protecting the hand and was easily removed with a towel wet with room temperature water only, and required no steam or other chemicals.

Thus the “sacrificial coating” effectively protected the treated hand and the graffiti was easily removed with a towel wet only with room temperature water, without the need for steam or chemical treatment. The indelible ink on the control hand surface remained visible even after the cleaning step.

The treated hand surface exhibited removal of the graffiti to a striking degree as compared to the control hand surface.

### Example 5

### Protection and Cleaning of a Painted Surface

The 2.5% polyethylene oxide aqueous solution and the control solution were prepared as described in Experiment 3 herein above.

Treatment of Painted Wall

The 2.5% polyethylene oxide aqueous solution was applied to a wall previously coated with a flat paint (“the treated wall surface”). The control solution was applied to a wall coated with a flat paint (“the control surface”). The surfaces were allowed to dry. After about 5 to 10 minutes, the surfaces were dry to the touch.

Graffiti

“Graffiti” in the form of pencil marks, black shoe polish, coffee and crayon marks were applied to the treated wall surface and to the control surface. After approximately 3 minutes, the Graffiti marked surfaces were dry to the touch. It was observed that the coating and graffiti remained intact.

Cleaning. Each of the surfaces was subjected to cleaning with a wet towel at room temperature to remove the graffiti. (The towel was wetted with water).

Results. The graffiti was removed completely with no stains on the treated surfaces with the following limitation: only the crayon marks required water temperature above room temperature for removal of the soiling agent. The crayon marks required approximately 50° C. water temperature for complete removal of the crayon marks. Graffiti applied to the control treated surfaces was not completely removed following the same cleaning treatment. Thus the residual “sacrificial coating” effectively protected the treated surface and the graffiti was easily removed with a wet towel, without the need for steam or chemical treatment. The coating and soiling due to the crayon marks were removed completely with no stain marks on the treated surface, which demonstrated that the sacrificial coating was effective in protecting the treated surface and was easily removed with a sponge soaked with warm water at approximately 50° C.; no steam or other chemical treatment was required.

Conclusion

The results show that the provided composition comprising polyethylene oxide provides an effective coating on a surface, which can protect against the permanent adhesion of different types of soiling agents. The provided composition is an effective anti-graffiti surface treatment.

### Example 6

### Protection and Cleaning of a Wall-Covering Surface

The 2.5% polyethylene oxide aqueous solution and the control solution were prepared as described in Experiment 3 herein above.

Treatment of Wall-Covering Surface

The 2.5% polyethylene oxide aqueous solution was applied to a wall-covering surface (“the treated wallpaper surface”). The control solution was applied to a wall coated with a flat paint (“the control surface”). The surfaces were allowed to dry. After about 5 to 10 minutes, the surfaces were dry to the touch.

Graffiti

“Graffiti” in the form of pencil marks, black shoe polish, coffee and crayon marks were applied to the treated wall surface and to the control surface. After approximately 3 minutes, the Graffiti marked surfaces were dry to the touch. It was observed that the coating and graffiti remained intact.

Cleaning. Each of the surfaces was subjected to cleaning with a wet towel at room temperature to remove the graffiti. (The towel was wetted with water).

Results. The graffiti was removed completely with no stains on the treated wallpaper surfaces with the following limitation: only the crayon marks required water temperature above room temperature for removal of the soiling agent. The crayon marks required approximately 50° C. water temperature for complete removal of the crayon marks. Graffiti applied to the control treated surfaces was not completely removed following the same cleaning treatment. Thus, the residual “sacrificial coating” effectively protected the treated wallpaper surface and the graffiti was easily removed with a wet towel, without the need for steam or chemical treatment. The coating and soiling due to the crayon marks were removed completely with no stain marks on the treated surface, which demonstrated that the sacrificial coating was effective in protecting the treated surface and was easily removed with a sponge soaked with warm water at approximately 50° C.; no steam or other chemical treatment was required.

Conclusion

The results show that the provided composition comprising polyethylene oxide provides an effective coating on a surface, which can protect against the permanent adhesion of different types of soiling agents. The provided composition is an effective anti-graffiti surface treatment.

The one-step cleaning and treatment functions to simultaneously clean and protect surfaces and thus reduces the cost and time necessary to clean and protect such a surface.

### Example 7

### Wall-Coverings With Protective Coating

The 2.5% polyethylene oxide aqueous solution and the control solution were prepared as described in Experiment 3 herein above.

The 2.5% polyethylene oxide aqueous solution was applied to a pre-pasted wall-covering surface using a roller (“the treated wallpaper”). The control solution was applied to a pre-pasted wall-covering surface (“the control wallpaper”). The surfaces were allowed to air dry. After about 24 hours, the surfaces were dry to the touch. Each of the pre-pasted treated wallpaper and control wallpaper was dipped completely into a trough of water and “booked” while wet, to allow the paper to stabilize in size and then place onto a wallboard and smoothed in place with a sponge. The wallpaper was allowed to dry overnight.

Soiling

“Soiling” in the form of tenacious stains, including pencil marks, crayon marks, tomato sauce, mustard, black brake grease and black shoe polish was applied to the wallpaper. It was observed that the coating and graffiti remained intact.

Results. After the wallpaper was “booked” the coating was observed to survive the soaking in water. The soil marks (pencil marks, tomato sauce, mustard marks, black brake grease and black shoe polish were removed completely with no stain marks on the treated wallpaper with the following limitation: only the crayon marks required the use of a soft brush with warm water without harsh scrubbing for removal of the soiling agent. Soil marks applied to the control treated wallpaper was not completely removed following the same cleaning treatment. Thus the residual “sacrificial coating” effectively protected the treated wallpaper and the soil marks were easily removed, without the need for steam or chemical treatment.

Conclusion

The sacrificial coating was residually present on the wallpaper and even after repeatedly applying pencil marks and subsequent cleaning with water, the coating was effective in protecting the wallpaper.

Throughout this application, various publications and patents are referenced. The disclosures of these publications in their entireties are hereby incorporated by reference into this application in order to more fully describe the state of the art.

This invention may be embodied in other forms or carried out in other ways without departing from the spirit or essential characteristics thereof. The present disclosure is therefore to be considered as in all respects illustrative and not restrictive, the scope of the invention being indicated by the appended claims, and all changes which come within the meaning and range of equivalency are intended to be embraced therein.

### Example 8

### Cleaning and Protecting Inanimate Surfaces

Preparation of a Cleaning and Protective Removable Coating Composition.

Polyethylene oxide aqueous solution was prepared by adding 2.5 grams of polyethylene oxide to 100 ml of water. The solution was mixed at high speed until the solution was clear. The solution was 2.5-weight percent polyethylene oxide aqueous solution. (“the 2.5% polyethylene oxide aqueous solution”).

Anionic surfactant solution was prepared by adding 2.6 grams of sodium dodecylbenzene sulfonate to 100 ml water. The solution was mixed at low speed until the solution was clear. This solution is the 2.6 weight percent anionic surfactant solution (“2.6% anionic surfactant solution”).

Aqueous Cleaning and Protective Coating solution was prepared by combining (a) 20 ml of the 2.5% polyethylene oxide aqueous solution and (b) 80 ml of the 2.6% anionic surfactant solution. The components were mixed for approximately 10 to 30 seconds. (“the cleaning and coating solution”).

Cleaning and Coating Surfaces.

“Graffiti” in the form of indelible ink marks was applied to an uncoated clean ceramic tile surface on two areas (Area “A” and Area “B”) of the tile. The surface was allowed to dry for approximately 30 minutes.

Cleaning.

One area of the graffiti treated ceramic tile surface (Area A) was subjected to cleaning with a wet paper towel at room temperature to remove the graffiti. The other area of the graffiti treated ceramic tile (Area B) was subjected to cleaning with “the cleaning and coating solution” using a wet paper towel at room temperature to remove the graffiti.

Results

The graffiti was completely removed from Area B of the ceramic tile with no residual stains. The graffiti was not completely removed from Area B of the tile. Thus, the use of “the cleaning and coating solution” was effective in cleaning and removing the graffiti from the tile surface. Without rinsing, Area B was allowed to dry at room temperature.

Re-Cleaning

The area cleaned with “the cleaning and coating solution” (Area B) was then re-treated with indelible ink marks and the area allowed to dry for approximately 30 minutes.

Graffiti applied to area (B) was removed using a wet paper towel at room temperature indicating that the cleaning and coating solution provides an invisible protective coating and facilitates the removal of graffiti without the need for hat water or steam or harsh chemical treatments.

Graffiti applied to the other area (A) was not removed using a wet paper towel at room temperature.

Shielding.

Additional experiments indicated that tile surfaces coated with the provided cleaning and coating solution stayed clean longer than uncoated surfaces when the surfaces were subjected to airborne dirt and environmental grime, including automobile exhaust, smog and dust. Thus, the coated (“shielded”) surfaces exhibited “dirt resistence.”

I claim:

1. A process of coating a surface comprising the step of: (a) applying to a surface a composition comprising
i. a solution of polyethylene oxide in water, wherein the polyethylene oxide has a molecular weight greater than 250,000, and
ii. a surfactant, wherein the composition is capable of being removed from the surface at about room temperature with a solvent.

2. The process of claim 1, further comprising the step of: (b) drying the surface.

3. The process according to claim 2, wherein the drying step is conducted at about 1-250 degrees Centigrade.

4. The process according to claim 1, further comprising the step of: removing the coating by applying an aqueous solution to the coated surface.

5. The process according to claim 4, wherein the aqueous solution is water.

6. The process according to claim 5, wherein the solution is at a temperature of about less than 85 degrees Centigrade

7. The process according to claim 1 further comprising step of: applying an additional amount of the composition of claim 1 to the surface.

8. The process according to claim 1, wherein the surface is inanimate.

9. The process according to claim 1, wherein the surface is animate

10. The process according to claim 9, wherein the animate surface is human skin.

11. An article of manufacture comprising a surface treated with the composition of claim 1.
